(19) United States
(12) Patent Application Publication
(10) Pub. No.: US 2015/0019098 A1
(43) Pub. Date: Jan. 15, 2015

(54) SIGNAL TRANSMITTER, SYSTEM AND METHOD FOR HIGHLIGHTING OBJECTS IN ROAD TRAFFIC, USE OF THE SYSTEM, AND USE OF THE SIGNAL TRANSMITTER

(71) Applicant: Continental Teves AG &Co. oHG, Frankfurt (DE)

(72) Inventors: Sighard Schräbler, Karben (DE); Stefan Lüke, Bad Homburg (DE); Ronald Bayer, Mühlheim/Main (DE); Ulrich Stählin, Eschborn (DE); Peter Rieth, Eltville (DE)

(21) Appl. No.: 14/374,253

(22) PCT Filed: Nov. 23, 2012
(86) PCT No.: PCT/EP2012/073459

§ 371 Date: Jul. 24, 2014

(30) Foreign Application Priority Data
Feb. 3, 2012 (DE) 10 2012 201 603.1
Oct. 19, 2012 (DE) 10 2012 219 106.2

(51) Int. Cl. B60T 7/00; G06K 7/12; G06K 19/06

(52) U.S. Cl. CPC B60T 7/00; G06K 19/0614; G06K 19/06084; G06K 7/12; B60W 2550/22
USPC 701/70; 250/271

(57) ABSTRACT

A signal generator for highlighting objects in road traffic, including a marker and a carrier material. The marker is arranged on the carrier material in such a manner that the marker covers one surface side of the carrier material and/or is added to a substance of the carrier material. The signal transmitter reflects incident electromagnetic radiation of at least one predeterminable wavelength band by the marker. A spectral width and a spectral position of the at least one predeterminable wavelength band are distinguished by a size and/or a size distribution and/or a shape of nanoparticles contained in the marker and/or by a surface nanostructuring of the marker. The spectral position of the at least one predeterminable wavelength band is located in an infrared spectral range. The invention further relates to a corresponding system, a corresponding method, the use of the signal generator, and the use of the system.

### CROSS REFERENCE TO RELATED APPLICATIONS

This is the U.S. National Phase Application of PCT International Application No. PCT/EP2012/073459, filed Nov. 23, 2012, which claims priority to German Patent Application No. 10 2012 201 603.1, filed Feb. 3, 2012 and German Patent Application No. 20 2012 219 106.2, filed Oct. 19, 2012, the contents of such applications being incorporated by reference herein.

### FIELD OF THE INVENTION

The invention relates to a signal transmitter for highlighting objects in road traffic, a system for highlighting and recognizing objects in road traffic, a method for highlighting and recognizing objects in road traffic, a use of the signal transmitter, and a use of the system.

### BACKGROUND OF THE INVENTION

The prior art discloses various generic types of driver assistance systems, which essentially have in common the fact that they serve to relieve the burden on the driver in traffic situations. However, such driver assistance systems often also manifest hazard-preventing measures going beyond a pure convenience effect, e.g. in the form of warnings issued to the driver or even interventions in control of the vehicle. In this case, the required detection of information is based partly on environment sensor technology, on digital map material or else on vehicle-to-X communication. All these systems rely here on the highest possible reliability and a high density of the information detected. In order that the detection of information for such systems or else for the driver himself/herself is simplified and thus made more effective, it is known, moreover, to provide road users or else traffic signs with special markings.

In this context, DE 10 2010 031 254 A1, which is incorporated by reference, discloses a traffic safety communication system for increasing the traffic safety of pedestrians. The traffic safety communication system comprises a traffic safety communication device integrated into a pedestrian's shoe and a safety risk analysis device in a vehicle. The safety risk analysis device transmits a signal which activates the energy supply of the traffic safety communication device if it is received by the latter. If the traffic safety communication device has been activated, it in turn transmits a signal from which the safety risk analysis device determines a position, a walking pace and, if appropriate, a tendency toward increased endangerment potential (e.g. upon recognition of a child) of the pedestrian. If the safety risk analysis device ascertains an actual endangerment of the pedestrian by the vehicle in which said device is situated, a corresponding warning is issued to the driver.

DE 100 28 219 A1, which is incorporated by reference, discloses a marking device for persons which can be attached to the clothing of the person, for example, and indicates the position of the person by means of an invisible radiation signal or else acoustic or optical signals. The marking device additionally itself detects data from its surroundings and can thus make the person aware of possible hazards.

DE 10 2008 061 301 A1, which is incorporated by reference, describes a validation of information detected by means of environment sensors by other environment sensor information, which can be used for so-called “Target Validated Braking”, for example. For this purpose, a radar signal is validated by means of a camera signal by virtue of the camera signal confirming that the radar signal is reflected by a vehicle. An additional distance measurement by means of a stereo camera is not provided. On account of this validation by a second sensor, the reliability of the information is high enough to initiate an autonomous braking operation for accident avoidance.

DE 10 2008 023 972 A1, which is incorporated by reference, discloses a method and a device for recognizing traffic-relevant information in a moving vehicle. For this purpose, sensor data of a sensor and map data of a navigation system are interpreted for recognizing the traffic-relevant information. In this case, the sensor can be embodied as a visual sensor in the form of a camera looking in the direction of travel. The sensor data and map data are fed to a control mechanism and evaluated by the latter. In the context of the evaluation, e.g. a speed limit recognized by the camera in the form of a traffic sign is firstly matched to the map data. If the map data confirm the validity of the speed limit, the speed limit is indicated to the driver.

However, the devices and systems known in the prior art are disadvantageous for various reasons. In this regard, the known signal transmitters, for interaction with the corresponding systems, often rely on a dedicated energy supply in order to generate a signal actively. As a result, their availability is dependent on the presence of a sufficient quantity of energy, e.g. in the form of a battery, or a suitable generator. However, this makes such marking devices firstly more expensive and secondly less reliable than passive marking devices, which do not actively generate a signal, but rather merely reflect back optically visible light impinging on them substantially in the initial direction thereof. One example of such passive signal transmitters is, firstly, so-called “cat's eyes”, for example for highlighting road users, and, secondly, also road signs, which are usually provided with an optically reflective coating. However, this type of signal transmitters has the disadvantage that, on account of their comparatively low recognition reliability, in accordance with the prior art, this type of signal transmitters has to be detected redundantly at least once e.g. by means of different environment sensor technology, in order to achieve a reliability sufficient for an autonomous intervention in the control of a vehicle. Moreover, the known signal transmitters suitable for highlighting road users have in common the fact that, by virtue of their external constitution and their appearance, they are not suitable for not adversely affecting a fashionable character of a garment or a fashion-conscious demeanor of a person, which is why their use is often avoided despite their safety-increasing effect.

### SUMMARY OF THE INVENTION

Therefore, the problem addressed by the invention is that of proposing a signal transmitter for highlighting objects in road traffic which overcomes the disadvantages known from the prior art.

This problem is solved according to an aspect of the invention by means of the signal transmitter for highlighting objects in road traffic.

The signal transmitter according to an aspect of the invention for highlighting objects in road traffic comprises a marking means and a carrier material, wherein the marking means is arranged on the carrier material in a manner covering at least one surface side of the carrier material and/or is admixed with a substance of the carrier material, and wherein the signal transmitter reflects impinging electromagnetic radiation in at least one predeterminable wavelength band by means of the marking means. The signal transmitter according to the invention is distinguished by the fact that a spectral width and a spectral position of the at least one predeterminable wavelength band are influenced by a size and/or a size distribution and/or a shape of nanoparticles contained in the marking means and/or are influenced by a surface nanostructuring of the marking means, wherein the spectral position of the at least one predeterminable wavelength band lies in an infrared spectral range.

This firstly affords the advantage that a so-called passive signal transmitter, that is to say a signal transmitter without a dedicated energy supply, for highlighting objects in road traffic is provided. By dispensing with the dedicated energy supply, the signal transmitter is comparatively uncomplicated and cost-effective in terms of its production. Moreover, its functionality is not restricted either by the lifetime of a battery or by the functionality of a generator known in the prior art. In particular, dispensing with a dedicated generator for the energy supply enables a comparatively high robustness and reliability of the signal transmitter according to the invention since said signal transmitter thus comprises no components at all that are subjected to permanent mechanical loading.

The use of nanoparticles or else the alternative surface nanostructuring of the marking means affords the further advantage that the reflection properties in the form of the spectral width and the spectral position of the at least one predeterminable wavelength band can be set in a targeted manner. In this regard, by way of example, comparatively narrow reflective wavelength bands with sharp transitions to a non-reflective wavelength range can be produced. This is because it has been found that nanoparticles or a surface nanostructuring enable(s) a targeted setting of novel optical properties or novel optical functionalities of materials and surfaces. The nanoparticles can e.g. also be contained in a dye applied to the carrier material.

If a surface nanostructuring is used instead of the nanoparticles for producing and setting the spectral width and the spectral position of the at least one predeterminable wavelength band, then the surface nanostructuring has a topographical profile whose height structuring substantially corresponds to the size of nanoparticles which reflect in a wavelength band.

The use of the nanoparticles or the surface nanostructuring furthermore makes it possible to produce a plurality of wavelength bands which are spaced apart with a settable spectral spacing and which in each case reflect the impinging electromagnetic radiation of the corresponding wavelengths. Consequently, e.g. a wavelength-dependent intensity modulation of the reflected electromagnetic radiation can be brought about. Since the perceived structure size is additionally variable with the viewing angle, the orientation (e.g. oblique impingement of the electromagnetic radiation or perpendicular impingement of the electromagnetic radiation) can be determined therefrom. This property can be used according to the invention in order to determine an alignment of the highlighted object for different applications.

The marking means of the signal transmitter can be embodied either as a solid or as a liquid, suspension or powder. Since the effect according to the invention is brought about by the marking means, the sole prerequisite for the carrier material is that the latter is suitable for coating with the marking means or for admixture with the substance of the marking means. Examples of suitable marking means are, for instance, textiles, plastics, metals and lacquers. In the case of textiles and lacquers, in particular, the marking means can be arranged on the carrier material in a simple manner. This allows the signal transmitter e.g. also to be attached to articles whose optical appearance would otherwise be altered or influenced by a conventional reflector such as, for instance, a so-called “cat's eye”. In the case of fashionable garments or fashionable accessories, in particular, this is a significant advantage since these articles can be provided with the signal transmitter according to the invention, without their fashionable character or their design or their esthetic value being reduced. Consequently, it is therefore possible to highlight pedestrians in road traffic in a suitable and effective manner in order to improve their recognizability and visibility. This in turn can help to reduce the number of pedestrians injured or killed in traffic accidents.

A further advantage arises from the spectral position of the at least one predeterminable wavelength band in the infrared spectral range. As a result, the reflected electromagnetic radiation is positioned in a spectral range separate from visible light and is thus invisible to the human eye. Firstly, this likewise contributes to maintaining a design or fashionable character of a garment, since the reflective effect of the signal transmitter is not discernible to the human eye either. Secondly, it simplifies the reliable recognition of the signal transmitter, since the latter reflects in a wavelength band separate from the visible spectral range and is thus recognizable as a signal transmitter according to the invention comparatively simply on the basis of its wavelength.

The signal transmitter according to the invention is preferably detected and recognized as such by a driver assistance system of a motor vehicle that detects in the infrared spectral range. The driver assistance system, upon detecting the signal transmitter, can initiate a reaction which is appropriate to the situation and which extends from an autonomous control intervention, in particular emergency braking, through warning the driver to total passivity of the driver assistance system, if no endangerment is recognized and therefore no reaction at all is necessary.

An aspect of the invention affords the advantage of a very cost-effective method for highlighting pedestrians, in particular children, cyclists and motorcyclists, but also traffic-relevant facilities such as warning signs or roadway boundaries, in road traffic.

It is preferably provided that the carrier material can be chosen suitably for incorporation into garments and/or pieces of jewelry and/or transport containers without reducing the esthetic value thereof and/or without altering the style of appearance thereof, wherein the garments are in particular shoes and/or headgear, wherein the pieces of jewelry are in particular bracelets and/or hair ornaments, and wherein the transport containers are in particular rucksacks and satchels and/or bags. This affords the advantages already mentioned with regard to the arrangement of the signal transmitter or of a plurality of signal transmitters on pedestrians and also cyclists, or on the clothing thereof. By virtue of the carrier material being selected in a targeted manner in such a way that it can be incorporated into the articles mentioned, without changing their esthetic value or without changing their style and appearance, a high acceptance of the signal transmitter can be assumed, which in turn fosters a correspondingly high rate of outfitting. This results in an effective way of preventing traffic accidents involving pedestrians, cyclists and other unprotected road users.

Preferably, the signal transmitter according to the invention can be applied in a simple manner to garments of any type, such as e.g. jackets, caps, shirts, trousers and/or shoes, even after they have been produced and sold to the end customer. This can be made possible, for example, by a suitable textile material being chosen as the carrier material.

Moreover, it is preferred for the carrier material to be a garment and/or a piece of jewelry and/or a transport container, wherein the garment is in particular a shoe and/or an item of headgear, wherein the piece of jewelry is in particular a bracelet and/or a hair ornament, and wherein the transport container is in particular a rucksack and/or a satchel and/or a bag. This leads to the further advantage that the signal transmitter no longer has to be arranged on the articles mentioned or incorporated into them, rather the articles mentioned themselves constitute the signal transmitter since they form the carrier material which is covered with the marking means at least on one surface side. This can further increase the acceptance of the signal transmitter according to the invention. As already described, the marking means can be embodied either in the form of nanoparticles arranged on the carrier material, or in the form of a surface nanostructuring, which can also itself be part of the carrier material. In the latter case, therefore, a surface of the carrier material is used as marking means.

The satchels can be provided proportionally or else completely with the signal transmitter according to the invention; by way of example, a specific, nanostructured fiber can be used for producing them. In this case, the signal transmitter does not have to be regularly applied to the satchel anew, since the satchel at least proportionally consists of the signal transmitter and the highlighting is thus permanent. If corresponding signal detection modules comprising e.g. a spatially resolving camera are available, a machine-readable information item in the form of a symbol or a barcode can also be contained. A machine-readable information item in the form of a specifically selected reflected infrared wavelength of the electromagnetic radiation is also possible. In addition, such a machine-readable information item can also be represented in a manner optically discernible to the human eye in the visible wavelength spectrum. By way of example, a barcode that is detectable only in the infrared could be combined with a pictogram that is discernible to the human eye, wherein the barcode and the pictogram describe the same information item or the same information items. In this case, a human observer has the possibility of checking the information read out by a corresponding system, which further increases the safety of the method according to the invention.

It is expediently provided that the marking means is a clothing detergent and/or a shampoo and/or a shoe polish and/or a skin cream and/or a lacquer and/or a fiber and/or a powder and/or a suspension and/or a solution and/or a paste, wherein the fiber can be used in particular for producing fabrics and/or textiles. This increases the range of application of the signal transmitter according to the invention since said signal transmitter, by means of the embodiments of the marking means mentioned, can be transferred or applied to a multiplicity of other articles or even to persons. By way of example, when a shoe polish is used as marking means, shoes cleaned with this shoe polish are provided with the marking means and thus have the properties already described. The signal transmitter can likewise be applied directly to a person if, for instance, a shampoo or a skin cream is used as marking means. If a fiber is used as marking means and a garment, e.g. a coat, is produced from said fiber, this affords the particular advantage that the signal transmitter is comparatively large and thus manifests a comparatively large highlighting effect. Preferably, exclusively materials which are harmless from the standpoint of health are used for this embodiment variant. Particularly if a shampoo or a skin cream is involved, particular attention should be directed to harmlessness and compatibility from the standpoint of health. By way of example, nanoparticles composed of silver, so-called “nanosilver”, should be avoided since they may give rise to an effect possibly harmful to health.

If the signal transmitter is contained in a clothing detergent, it adheres to the corresponding garment after a washing process with the clothing detergent. In this case, the attachment of the signal transmitter to the garment can therefore be brought about by the end customer himself/herself by means of the use of a corresponding clothing detergent.

A lacquer used as marking means is particularly preferably used for coating a traffic sign or the road surface, while the fiber is particularly preferably used for producing high-visibility clothing conspicuous to traffic.

It is furthermore preferred that the marking means can be applied to the carrier material by means of a spraying device, in particular by means of a spray can. This affords a simple possibility for attaching the signal transmitter according to the invention to different types of objects or for using the objects as carrier material. For this embodiment variant, a suspension that adheres to and dries on an object or a sprayable lacquer is preferably used as marking means. In this way, e.g. garments, bags, rucksacks but also any type of stationary object can be provided with the signal transmitter.

It is preferably provided that the marking means does not permanently adhere to the carrier material. By way of example, a signal transmitter attached to a garment by means of a spraying device can be removed again by the garment being washed. This, too, can increase the willingness to use the signal transmitter since the application thereof in particular to garments is thus to the greatest possible extent not irreversible. In order to ensure permanent highlighting of the marked object, regularly renewed application becomes necessary in this case.

The highlighting of satchels of school children with the signal transmitter according to the invention is particularly preferred. The highlighting can either be attached as early as during the production of the satchel, or be attached later by the end customer himself/herself, e.g. by means of a spray can. Since the signal transmitter is imperceptible to the human eye owing to its use of infrared wavelengths, this affords the advantage particularly for children that an alteration of the design or of the appearance of the satchel, said alteration possibly being felt to be disturbing, fails to appear. This solves the problem that many children to whom the appearance of known signal transmitters—such as e.g. optical reflector elements and so-called cat's eyes—is visually perceptible and found to be unaesthetic thus refuse to wear or carry high-visibility clothing, caps or satchels provided with such signal transmitters, even though they can make a significant contribution to said children's safety in road traffic.

If appropriate, the signal transmitter has to be regularly applied anew, since the marking effect is only of limited time duration depending on the type of adhesion (e.g. spray or cream) and constitution of the highlighted object (e.g. clothing or skin). If the signal transmitter is in indirect or direct contact with part of the human body, in this case as well particular attention is paid to the harmlessness of all materials used from the standpoint of health.

Moreover, it is preferred for the signal transmitter to keep at least one coded information item in machine-readable form, wherein the coded information item is contained in an at least one-dimensional barcode and/or a wavelength and/or at least one two-dimensional symbol. This affords the advantage that not just the information about a mere presence of an object provided with the signal transmitter is communicated, rather that furthermore e.g. a coded information item, describing the object, is communicated. The coded information item can be an object property, such as e.g. whether the object is a living object or an inanimate object. In particular, the information item can describe the object as a child. Since the electromagnetic radiation reflected by the signal transmitter is imperceptible to the human eye, the at least one-dimensional barcode or the at least one two-dimensional symbol is not perceived by the human eye either and is therefore not found to be disturbing. An advantage that additionally arises from the lack of perceptibility to the human eye in this connection resides in the fact that malicious intentions for misusing the signal transmitter are reduced since the signal transmitter is inconspicuous or imperceptible.

It is particularly preferably provided that an at least one-dimensional barcode attached on a road sign or a symbol attached on a road sign is also perceptible in the spectral range visible to the human eye, in order to further improve the recognition range and reliability of the recognizability of the signal transmitter by virtue of the greater width of the predeterminable wavelength band. In particular, it is even provided that a road sign on which a barcode or a symbol was attached contains no other items of information at all in another form. Such a road sign therefore has exclusively the barcode or the symbol and the information contained by the barcode or by the symbol in coded form is not comprehensible to a human observer.

The term machine-readable should be understood broadly within the meaning of the invention and relates to the evaluation of a pattern, of a symbol or of a barcode by means of an infrared-sensitive camera or an infrared-sensitive laser scanner or any other device suitable for this purpose. If the pattern, the symbol or the barcode extends into the visible spectrum, it is not absolutely necessary, moreover, for the laser scanner or the camera to be infrared-sensitive.

In particular, it is preferred that the at least one coded information item describes a generic type of the object. As a result, by way of example, different types of road signs and different types of road users can be differentiated, without the need for a complex image recognition algorithm to be computed by a corresponding vehicle-side image recognition device. The signal transmitter according to the invention thus helps a vehicle-side image recognition device to interpret a context better. This simplifies the autonomous recognition of objects in road traffic and simultaneously increases the recognition reliability. In particular, in this way children in road traffic can be identified and recognized as such, which is advantageous in so far as children are especially endangered on account of their often careless behavior.

Furthermore, it is preferred for the objects to be road users and/or traffic information providers wherein the road users are in particular vehicles and/or pedestrians and/or bicycles, and wherein the traffic information providers are in particular road signs and/or roadway markings and/or kilometer posts and/or traffic lights and/or lamp posts and/or reflector posts and/or traffic cones. This affords the advantage that precisely those objects in road traffic are highlighted to which generally particular attention should be paid. Specifically, in the case of the road users mentioned, particular attention is required in so far as they are particularly vulnerable to motor vehicles. On the other hand, the traffic information providers mentioned communicate traffic-relevant information, for which reason particular attention should be paid to them as well.

It is expediently provided that the nanoparticles consist of a noble metal, in particular of gold, and/or of an alkali metal. It has been found that there is a relationship between the size and/or shape of electrically conductive nanoparticles and the spectral reflection maximum. In this case, the invention makes use of the effect that electromagnetic radiation impinging on an electrically conductive nanoparticle excites the electron cloud of the nanoparticle to vibrate, wherein a portion of the electromagnetic radiation is absorbed, while at the same time the electromagnetic radiation is subjected to a high degree of wavelength-dependent scattering influenced by the size and shape of the nanoparticle. Since the nanoparticles generally have a specific, unavoidable size distribution, the wavelength band has a spectral width. The size distribution generally has the response of a so-called Gaussian curve. The wider the Gaussian curve that represents the size distribution, the greater also the width of the reflected wavelength band.

As well as with gold, comparatively good experimental results were also obtained with silver, titanium, copper and various alkali metals, e.g. with sodium. Noble metals are particularly well suited to producing the nanoparticles because their electrical conductivity is not impaired by oxidation and, consequently, the properties of their electron cloud likewise remain unaffected.

It is preferred for the nanoparticles to be produced by means of ablation, in particular laser ablation, and/or abrasion. Ablation processes, in particular laser ablation processes, are methods in which the nanoparticles arise as a result of the action of heat on a basic body and are released from the basic body as a result of the action of heat. In an abrasion process, the nanoparticles arise as a result of being abraded from a basic body. Both methods have comparatively well-controllable process conditions and are therefore advantageously suitable for producing the nanoparticles with the desired size and/or size distribution and/or shape.

Moreover, it is preferred that the size and/or the size distribution and/or the shape of the nanoparticles are/is established in a self-assembled fashion, preferably by means of use of repelling van der Waals forces i.e. with the presence of a negative Hamaker constant. So-called self-assembly is an effect which occurs in the region of nanoparticles or nanostructured surfaces under specific process conditions. Depending on the process conditions, self-assembly occurs here to different extents or in different manifestations. The invention makes use of the effect of self-assembly in the production of the nanoparticles in so far as the latter thus have a comparatively uniform size and/or shape. This enables the predeterminable wavelength band to be particularly narrowband and, in association therewith, the possibility of particularly sharp transitions of the predetermined wavelength band to a non-reflective spectral range. By using van der Waals forces for self-assembly, recourse is had to an already known, calculable and predeterminable effect which allows correspondingly predeterminable properties to be obtained with regard to the size and/or the size distribution and/or the shape of the nanoparticles. By having recourse to the so-called Hamaker constant for determining the van der Waals forces, this furthermore affords a possibility of comparatively precisely predicting the size of the van der Waals forces used for self-assembly, since the Hamaker constant represents a variable describing the force acting between two nanoparticles. The Hamaker constant is accorded comparatively high importance in particular in the physical description of van der Waals forces acting in dispersions and suspensions. The Hamaker constant itself can be determined in this case from the dielectric constant or the ionization potential of the nanoparticles.

It is furthermore expedient that the marking means has a reflection maximum in the infrared spectrum, in particular in the near infrared spectrum of 700 nm to 1000 nm. This spectral range is not perceptible to the human eye, as a result of which the marking means itself is not perceptible either. Consequently, an optical appearance of the signal transmitter is substantially only influenced by the virtually arbitrarily selectable carrier material. The signal transmitter is therefore generally not felt to be disturbing visually. Furthermore, the aforementioned spectral range of 700 nm to 1000 nm has both good propagation properties and a sufficiently high transmissivity through a heat insulation glazing of a vehicle, as a result of which the signal transmitter can be detected by a signal detection module of a vehicle. An additional factor is that the reliable and particularly cost-effective silicon-based photodiodes that have already been known for a long time can be used in this wavelength range.

The invention furthermore relates to a system for highlighting and recognizing objects in road traffic, comprising at least one signal transmitter and at least one signal detection module, wherein the at least one signal transmitter reflects impinging electromagnetic radiation in at least one predeterminable wavelength band, and wherein the at least one signal detection module detects an electromagnetic radiation reflected by the at least one signal transmitter by means of at least one infrared-sensitive detection element. The system according to the invention is distinguished by the fact that the at least one signal transmitter is the signal transmitter according to the invention that has already been comprehensibly described. The advantages of the signal transmitter according to the invention have already been set out. The inclusion of the signal transmitter in a system according to the invention comprising a signal detection module for detecting the electromagnetic radiation reflected by the signal transmitter affords the additional advantage that an effective recognition of the signal transmitter and, if appropriate, an evaluation of information items of the signal transmitter that are kept in coded form are made possible within the system.

It is advantageously provided that the signal detection module irradiates the at least one signal transmitter by means of at least one radiation element with electromagnetic radiation in a predeterminable wavelength band, in particular with electromagnetic radiation in the near infrared spectrum of 700 nm to 1000 nm. Having recourse to this spectral range leads to the advantages already described with regard to the lack of perceptibility to the human eye and the comparatively high transmissivity through a heat insulation glazing. The heat insulation glazing usually used has a reflection maximum for electromagnetic radiation in the mid-infrared spectrum, i.e. in the wavelength range of approximately 30 μm to approximately 50 μm. In addition, electromagnetic radiation in the wavelength range of 700 nm to 1000 nm is comparatively safe for humans, in particular for the human eye. Nevertheless, precautionary measures should be taken into consideration here as well if the radiation power exceeds specific power thresholds and in particular if the radiation power is concentrated or emitted in a coherent fashion. Moreover, radiation elements and detection elements that are effective in this spectral range are comparatively cost-effective.

In this case, the radiation element illuminates the region in front of the motor vehicle as far as a specific distance in the infrared and thus in a manner imperceptible to the human eye. If a signal transmitter according to the invention is situated in the region illuminated in the infrared, it reflects the electromagnetic radiation impinging on it, such that said electromagnetic radiation can be detected by the signal detection module.

Even in a simple embodiment of the system according to the invention comprising only one radiation element and only one detection element, it is thus possible to recognize reliably whether an object highlighted with the signal transmitter according to the invention or an intrinsically infrared-reflecting object is situated in the detection range of the detection element and thus generally in a hazard region in front of the vehicle.

It is expediently provided that the at least one radiation element is an LED, in particular an infrared LED. LEDs are comparatively cost-effective to produce and at the same time have a long lifetime and a low energy requirement.

Preferably, the radiation power of the at least one radiation element is chosen in such a way that damage and injuries to human and animal eyes can be precluded. The radiation power is comparable, in particular, with the radiation power of a conventional flashlight or, if appropriate, also of a motor vehicle headlight.

It is particularly expediently provided that the LED, in particular the infrared LED is energized in a pulsed fashion. This firstly increases the lifetime of the LED, since thermally caused wear effects are reduced. Secondly it improves the recognizability of the signal transmitter for the signal detection module, since the latter can search in a targeted manner for reflected electromagnetic radiation having the emitted pulse frequency.

In particular, it is particularly expedient that the at least one infrared-sensitive detection element and the LED, in particular the infrared LED, are operated in a synchronously pulsed fashion. Operating the at least one detection element and the LED synchronously affords the advantage that a so-called carrier frequency method can be used. Consequently, by way of example, all detected radiation that does not correspond to the pulse frequency of the detection element or of the LED can be rejected. This improves the signal-to-noise ratio and reduces the required emission power of the at least one LED.

Furthermore, it is preferred for the at least one detection element to be a photodiode and/or a camera and/or a laser scanner. In this case, a photodiode affords the advantages that it can be produced cost-effectively, has a long lifetime and is robust. A camera and a laser scanner, on the other hand, afford the advantages that they have a spatial resolution capability and can read out barcodes or two-dimensional symbols. Moreover, a determination of distance to the signal transmitter is possible by means of two cameras or a stereo camera.

In addition, it is preferred that the signal detection module comprises two mutually independent detection elements and a separating screen, wherein active detection regions of the detection elements are oriented in different directions on a horizontal plane, and wherein the detection regions are determined in particular by an arrangement of the separating screen. This affords the advantage that a recognition of direction becomes possible in a simple manner. If the signal transmitter is detected substantially equally well by all two detection elements, it is situated directly frontally ahead of the signal detection module. If it is detected only by one detection element because the separating screen masks the signal transmitter for the other detection element, then the signal transmitter is situated laterally frontally ahead of the signal detection module. The recognition of direction can be further improved or resolved more highly, the more detection elements and separating screens are used for shielding individual detection elements from specific solid angles. Such signal detection modules comprising an infrared LED as radiation element and two infrared photodiodes separated by a separating screen as detection elements are known as so-called “closing velocity” sensors and are already present in a large number of current vehicles.

The use of these “closing velocity sensors” that are already known and present in a large number of vehicles as signal detection modules means that the system according to the invention can be used for increasing safety in road traffic substantially without any additional cost expenditure on the vehicle side.

It is expediently provided that the at least one photodiode and/or the at least one camera and/or the at least one laser scanner are shielded against impinging electromagnetic radiation in a visible spectral range by means of a daylight barrier filter. This affords the advantage of reducing disturbing influences during the detection of the signal transmitter. This improves the reliability of the recognition of the signal transmitter and reduces erroneous recognitions.

In addition, it is advantageous that the signal detection module, by means of wavelength-selective filters and/or different wavelength-dependent sensitivities of different detection elements, is capable of reading out a coded information item contained in a reflected wavelength of the signal transmitter. This affords the advantage that an information item communicated by means of reflection of different wavelength bands is recognized as such by the signal detection module and can be read out. By way of example, the signal transmitter can reflect electromagnetic radiation in a wavelength band of 700 nm to 800 nm and in a further wavelength band of 900 nm to 1000 nm from the signal transmitter. The electromagnetic radiation reflected in such a way by means of a wavelength-dependent intensity modulation can contain for example an item of information about the type of object highlighted with the signal transmitter and can be read out by the signal detection module by means of the wavelength-selective filters and/or the different wavelength-dependent sensitivities of different detection elements.

In a further preferred embodiment, it is provided that the at least one camera and/or the at least one laser scanner, in a resolution-governed manner, is capable of reading out coded information items kept in an at least one-dimensional barcode and/or in a two-dimensional symbol of the signal transmitter. The already described types of information items can thus be read out in a simple manner by means of the camera and/or the laser scanner, if they are kept in an at least one-dimensional barcode and/or in a two-dimensional symbol of the signal transmitter.

Furthermore, it is preferred that a radiation power of the at least one radiation element and a reflectivity of the at least one signal transmitter and a sensitivity of the at least one detection element limit a recognition range of the system to 15 m. A recognition range in front of a vehicle that is usually relevant in town-city regions is thus detected. A recognition range of 15 m generally suffices, moreover, to stop the vehicle from a speed that is customary in a town-city region by means of an autonomous braking intervention and to prevent a collision with an object provided with a signal transmitter. Moreover, the restriction of the detection range to 15 m prevents signal transmitters outside a relevant range from being detected and leading to erroneous recognitions. Consequently, since a multiplicity of irrelevant objects are masked out from the outside, the system operates comparatively robustly and reliably.

It is expediently provided that the signal detection module is affiliated with a driver assistance system of a motor vehicle and is capable of initiating an autonomous braking intervention and/or an autonomous steering intervention and/or a warning of a driver by means of optical and/or acoustic and/or haptic warning means. Consequently, the system according to the invention can advantageously have recourse to a signal detection module that is present anyway in the motor vehicle, which reduces the implementation costs of the system in a vehicle. Moreover, a corresponding warning or even a braking or control intervention can be initiated by means of the driver assistance system—depending on the constitution of the driver assistance system.

Preferably, therefore, the signal detection module is designed in such a way that it can initiate an autonomous braking intervention in order to prevent a collision between the motor vehicle in which the signal detection module is arranged and the object that is highlighted by means of the signal transmitter or is intrinsically reflective. If the read-out device recognizes an object in the detection range, an autonomous braking intervention can be initiated. The autonomous braking intervention can be preceded, if appropriate, by an optical and/or acoustic and/or haptic warning to the driver, such that if the driver reacts sufficiently rapidly, a braking intervention is no longer necessary. Furthermore, the autonomous braking intervention can initially be restricted to a specific deceleration, for instance 0.3 g, and full braking is initiated only if the driver in turn initiates a braking process.

Given the presence of a spatially resolving camera with infrared capability or a plurality of infrared photodiodes having different spatial orientations, additionally or alternatively an autonomous steering intervention is preferably provided in order to avoid the object marked with the signal transmitter. In this case, analogously to the braking intervention, the steering intervention can initially be restricted to a specific, predefined steering angle and the setting of a larger steering angle becomes possible only if the driver in turn initiates a steering process. In this case, too, the intervention can be preceded by an optical and/or acoustic and/or haptic warning to the driver, such that if the driver reacts sufficiently rapidly, the intervention is no longer performed.

Moreover, it is advantageous that a housing of the detection module can be arranged on an inner side of a vehicle windshield by means of its wedge-shaped basic form. The inner side of a windshield of a vehicle offers largely optimal prerequisites for detecting the surroundings in front of the vehicle by means of the signal detection module, particularly if the latter is arranged in an upper region of the windshield, e.g. at the level of the rear-view mirror.

The present invention furthermore relates to a method for highlighting objects in road traffic, in which an object is highlighted by means of at least one signal transmitter, wherein the at least one signal transmitter reflects impinging electromagnetic radiation in at least one predeterminable wavelength band, and wherein an electromagnetic radiation reflected by the at least one signal transmitter is detected by at least one signal detection module. The method according to the invention is distinguished by the fact that the at least one signal transmitter is the signal transmitter according to the invention that has already been extensively described. The advantages of the signal transmitter according to the invention and of the system according to the invention comprising the signal transmitter have already been set out. In this case, the method according to the invention leads to the same advantages that have already been described.

It is preferably provided that the signal transmitter keeps at least one coded information item in machine-readable form, wherein the coded information item is contained in an at least one-dimensional barcode and/or a wavelength and/or at least one two-dimensional symbol, wherein the at least one signal detection module comprises a camera and/or a laser scanner which read(s) out the at least one information item, wherein the object is a traffic information provider, and wherein the traffic information provider is in particular a road sign and/or a roadway marking and/or a kilometer post and/or a traffic light and/or a lamp post and/or a reflector post and/or a traffic cone. Within the meaning of the invention, the road itself, i.e. for example the road surface, in a manner similar to a roadway marking, can also be used as a traffic information provider. In this regard, for instance, turnings, distances to parking lots, filling stations or the like can be applied to the road by means of the signal transmitter. The advantages arising from keeping coded information items in machine-readable form, having recourse to a camera and/or a laser scanner for reading out the coded information items and the arrangement of the signal transmitter on the objects mentioned have already been discussed.

In a further preferred embodiment, it is provided that the at least one information item read out is output optically and/or acoustically to a driver of a motor vehicle in a form comprehensible to said driver. This provides the driver of the motor vehicle with the possibility of reacting appropriately to the information.

Furthermore, it is preferred for the signal transmitter to be applied to a road surface by a motor vehicle. This embodiment can be advantageous for example in the reconstruction of an accident, if the vehicle, upon recognizing an unavoidable accident event, applies the signal transmitter to the road in order that the movement path of the vehicle directly before the occurrence of the accident is made reconstructable in a simple manner. Since the signal transmitter is not visible to the human eye, drivers of vehicles passing the accident scene later are not confused.

A further aspect of the invention additionally relates to a use of the system for highlighting and recognizing objects in road traffic in a driver assistance system of a motor vehicle.

Another aspect of the invention additionally relates to a use of the signal transmitter for highlighting objects in road traffic for keeping a multiplicity of information items in machine-readable form in a road sign.

### BRIEF DESCRIPTION OF THE DRAWINGS

Further preferred embodiments are evident from the dependent claims and the following description of an exemplary embodiment with reference to figures.

In the figures:

FIGS. 1a and 1b show a traffic sign highlighted according to an aspect of the invention, once in the visible spectral range and once in the infrared spectral range,

FIG. 2 shows the spectrum of visible light and of electromagnetic infrared radiation,

FIG. 3 shows a vehicle which reads a traffic sign highlighted according to an aspect of the invention,

FIG. 4 shows an exemplary signal detection module,

FIGS. 5a-5c show various embodiments of the signal transmitter according to an aspect of the invention, and

FIG. 6 shows one possible sequence of the method according to the invention in the form of a flowchart.

### DETAILED DESCRIPTION OF THE PREFERRED EMBODIMENTS

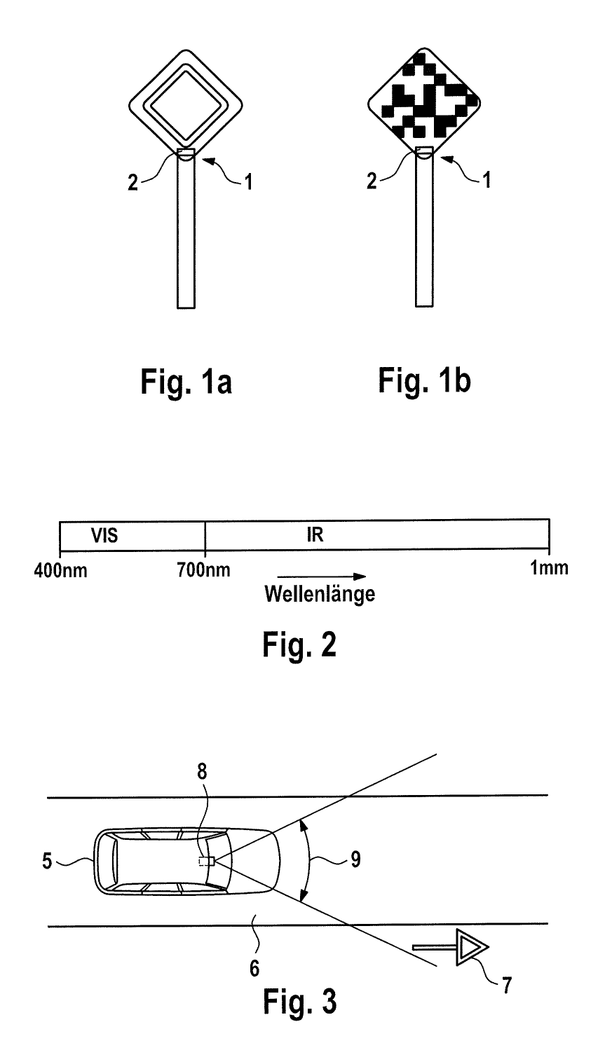

FIG. 1a shows road sign 1 such as is perceptible to the human eye without aids in the visible spectral range. Road sign 1 identifies a major road. By means of infrared illumination means 2 arranged on road sign 1, road sign 1 is illuminated with electromagnetic radiation in the infrared spectral range. A vehicle (not illustrated) having an infrared-sensitive camera can perceive traffic sign 1 in an infrared spectral range, as illustrated in FIG. 1b. In the infrared spectral range, a two-dimensional barcode can be recognized on traffic sign 1, said barcode being recognized and evaluated by the infrared-sensitive camera. In order to improve the reliability of the recognition and evaluation, the camera is additionally equipped with a daylight barrier filter which absorbs disturbing radiation influences from the visible spectral range. According to the example, the barcode illustrated firstly contains an item of information about the fact that traffic sign 1 is the identification of a major road. Furthermore, the exact GPS position of traffic sign 1 is contained in the barcode in order to determine or to correct the position of the vehicle on a digital map e.g. by means of a map matching method. The barcode consists of comparatively large individual elements in order to ensure a reliable and error-free read-out by way of the thus likewise comparatively large signal-to-noise ratio.

FIG. 2 illustrates the wavelength range of the visible spectral range VIS and of the infrared spectral range IR. As can be seen, the infrared spectral range adjoins the long-wave limit of the visible spectral range and is therefore no longer perceptible to the human eye. Therefore, the provision of objects with signal transmitters that reflect in an infrared spectral range is felt by humans neither to be confusing nor to be disturbing.

FIG. 3 shows vehicle 5 approaching traffic sign 7 on road 6. Traffic sign 7 does not have infrared illumination means, and so exclusively electromagnetic radiation incident on traffic sign 7 from the surroundings can be reflected. However, vehicle 5 has signal detection module 8, which emits infrared radiation cone 9 by means of an infrared LED. Said cone impinges on traffic sign 7 and is reflected there. The barcode visible only in the infrared on traffic sign 7 is now recognized and evaluated by signal detection module 8.

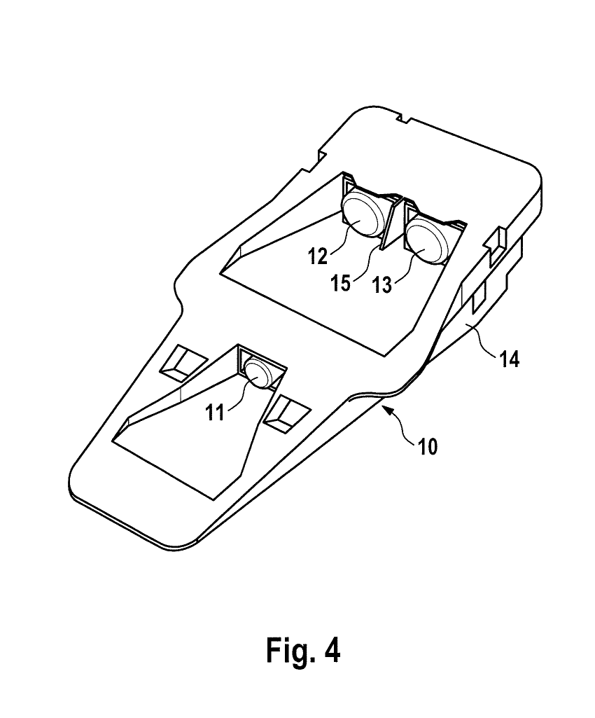

FIG. 4 illustrates by way of example signal detection module 10 comprising individual radiation element 11 and detection elements 12 and 13. In this case, radiation element 11 is embodied as an infrared LED, while detection elements 12 and 13 are embodied as infrared-sensitive photodiodes. Between detection elements 12 and 13, separating screen 15 fulfils a shading function which masks out electromagnetic radiation that is not directly frontally incident depending on the direction of incidence for detection element 12 or 13. Housing 14 is shaped in such a way as to ensure a simple arrangement of signal detection module 10 behind the windshield at the level of the rear-view mirror in the interior of the passenger compartment of a vehicle. Electrical links to an energy supply and a data bus are situated on the rear side of housing 14 and are not illustrated in FIG. 4. The radiation power emitted in the infrared spectral range is high enough to produce reflections in a range of up to 15 m, which reflections can be detected by detection elements 12 and/or 13, if an infrared-reflecting object is situated in the illumination region. Suitable objects are, for instance, sufficiently large metallic objects such as other vehicles or alternatively all types of objects highlighted with the signal transmitter according to the invention. If the reflected radiation in the infrared spectral range is detected simultaneously by both detection elements 12 and 13, read-out device 10 recognizes an object situated substantially directly frontally ahead within the detection range of 15 m. By contrast, if the reflected radiation in the infrared spectral range is detected only by an individual detection element 12 or 13, then signal detection module 10 recognizes an object situated laterally frontally ahead in the detection range. In this case, the reflected radiation in the infrared spectral range is detected only by individual detection element 12 or 13 owing to the shielding effect against laterally frontally incident radiation by separating screen 15. Depending on whether the reflected radiation in the infrared spectral range is detected by detection element 12 or 13, a left-right differentiation can be performed by signal detection module 10. Moreover, signal detection module 10 is able, upon recognizing an object situated in the detection range, to initiate a braking intervention and thus to prevent or at least moderate an imminent collision.

Such a signal detection module 10 described by way of example and comprising infrared LED 11 and infrared-sensitive photodiodes 12 and 13 is also known as so-called “closing velocity sensor”.

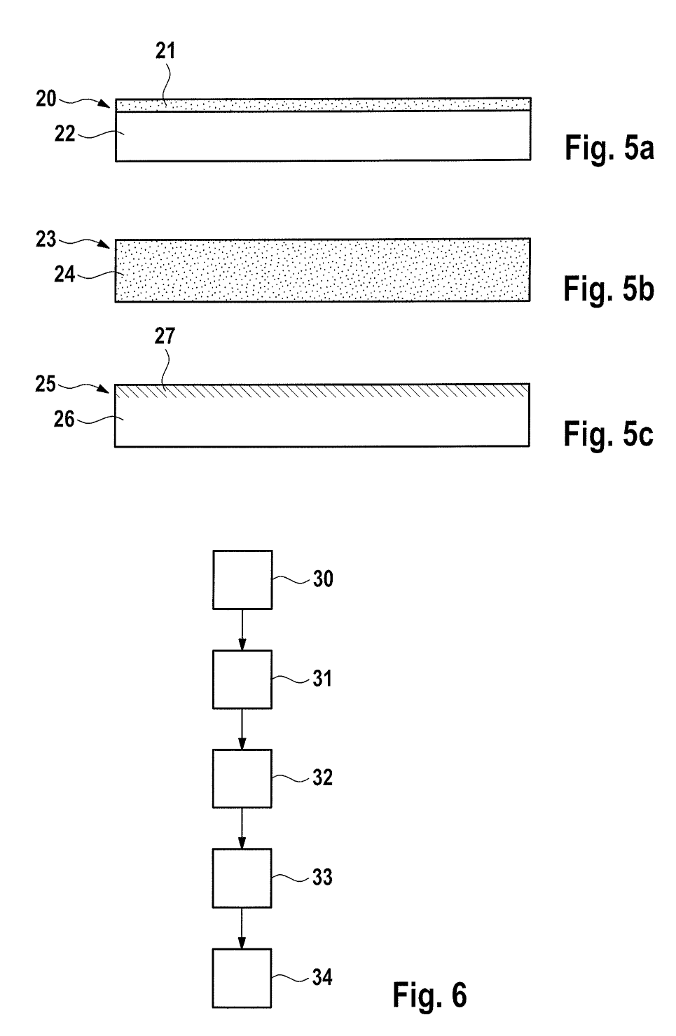

FIG. 5a reveals signal transmitter 20 according to the invention, comprising marking means 21 and carrier material 22. Marking means 21 is arranged on carrier material 22 in a manner covering a surface side of carrier material 22. Electromagnetic radiation in an infrared wavelength band that impinges on the surface side of carrier material 22 covered by marking means 21 is reflected by marking means 21 in a narrowband fashion. The spectral width and the spectral position of the infrared wavelength band within which impinging electromagnetic radiation is reflected is influenced by the size, size distribution and shape of nanoparticles contained in marking means 21. According to the example, marking means 21 is a sprayable suspension applied to carrier material 22 in a manner not permanently adhering thereto, by means of a spray can. In this case, carrier material 22 is a segment of a school child's satchel.

FIG. 5b illustrates signal transmitter 23 comprising carrier material 24 and marking means 24. Since the nanoparticles contained in marking means 24 were admixed with a substance of carrier material 24 as early as during the production of carrier material 24, a geometrical separation of carrier material 24 and marking means 24 is no longer possible. As a result of marking means 24 being admixed with the substance of carrier material 24, carrier material 24 now has the reflective properties of marking means 24. Consequently, each surface side of carrier material 24 is able to reflect impinging electromagnetic radiation in at least one predeterminable wavelength band. The spectral width and the spectral position of the wavelength band lie in an infrared spectral range and are influenced by the size, size distribution and shape of the nanoparticles contained in marking means 24. According to the example, signal transmitter 23 is embodied as a fluorescence body that fluoresces in the spectral range of visible light. Carrier material 24 is correspondingly a fluorescent plastic. Moreover, signal transmitter 23 is provided for being attached to satchels in order to satisfy DIN 58124, which prescribes that at least 20% of the surface of the satchel must be provided with fluorescent material. Signal transmitter 23 thus fluoresces in the visible spectral range, which increases the perceptibility to the human eye, and at the same time reflects in the infrared spectral range, which in turn allows perceptibility by a signal detection module according to the invention.

FIG. 5c shows signal transmitter 25 comprising carrier material 26. In this case, surface layer 27 has a surface nanostructuring that constitutes the marking means. Consequently, carrier material 26 and the marking means are composed of the same material and differ only in their different surface constitutions. In the case illustrated, therefore, the marking means is not formed by nanoparticles, but rather by the surface nanostructuring, which has a topographical profile of the order of magnitude of the nanoparticles already described.

FIG. 6 reveals one possible sequence of the method according to an aspect of the invention for highlighting objects in road traffic. In step 30, infrared radiation in a wavelength range of 700 nm to 1000 nm is emitted by means of a radiation element of a signal detection module. In step 31, the infrared radiation impinges on a signal transmitter according to the invention, which has a two-dimensional barcode visible only in the infrared spectral range, and said radiation is reflected by said signal transmitter. In step 32, the reflected infrared radiation is detected by an infrared-sensitive and spatially resolving camera of the signal detection module. The signal detection module establishes that the signal transmitter is situated laterally frontally ahead of the vehicle on which the signal detection module is arranged. Consequently, since there is not an acute risk of collision, no warning is initially issued to the driver. In the subsequent method step 33, the two-dimensional barcode is evaluated. The latter describes the object highlighted by means of the signal transmitter as a child. Since children often lack the necessary circumspection for hazard-aware behavior in road traffic, in step 34 an optical and acoustic warning is then actually issued to the driver of the vehicle in order to make said driver aware of the fact that the sudden occurrence of a hazard situation should be reckoned with on account of an assumable unpredictable behavior of the recognized child.

1. A signal transmitter e, for highlighting objects in road traffic, comprising a marking means and a carrier material, wherein the marking means is arranged on the carrier material in a manner covering at least one surface side of the carrier material and/or is admixed with a substance of the carrier material (22, 24, 26), and wherein the signal transmitter reflects impinging electromagnetic radiation in at least one predeterminable wavelength band by the marking means, wherein a spectral width and a spectral position of the at least one predeterminable wavelength band are influenced by a size and/or a size distribution and/or a shape of nanoparticles contained in the marking means and/or are influenced by a surface nanostructuring of the marking means, and wherein the spectral position of the at least one predeterminable wavelength band lies in an infrared spectral range.

2. The signal transmitter as claimed in claim 1, wherein the carrier material is incorporated into garments and/or pieces of jewelry and/or transport containers without reducing the esthetic value thereof and/or without altering the style of appearance thereof, wherein the garments are shoes and/or headgear, wherein the pieces of jewelry are bracelets and/or hair ornaments, and wherein the transport containers are rucksacks and/or satchels and/or bags.

3. The signal transmitter as claimed in claim 1, wherein the carrier material is a garment and/or a piece of jewelry and/or a transport container, wherein the garment is a shoe and/or an item of headgear, wherein the piece of jewelry is a bracelet and/or a hair ornament, and wherein the transport container is a rucksack and/or a satchel and/or a bag.

4. The signal transmitter as claimed in claim 1, wherein the marking means is a clothing detergent and/or a shampoo and/or a shoe polish and/or a skin cream and/or a lacquer and/or a fiber and/or a powder and/or a suspension and/or a solution and/or a paste, wherein the fiber can be used for producing fabrics and/or textiles.

5. The signal transmitter as claimed in claim 1, wherein the marking means can be applied to the carrier material by a spraying device.

6. The signal transmitter as claimed in claim 1, wherein the marking means does not permanently adhere to the carrier material.

7. The signal transmitter as claimed in claim 1, wherein the signal transmitter keeps at least one coded information item in machine-readable form, wherein the coded information item is contained in an at least one-dimensional barcode and/or a wavelength and/or at least one two-dimensional symbol.

8. The signal transmitter as claimed in claim 7, wherein the at least one coded information item describes a generic type of the object.

9. The signal transmitter as claimed in claim 1, wherein the objects are road users and/or traffic information providers, wherein the road users are vehicles and/or pedestrians and/or bicycles, and wherein the traffic information providers are road signs and/or roadway markings and/or kilometer posts and/or traffic lights and/or lamp posts and/or reflector posts and/or traffic cones.

10. The signal transmitter as claimed in claim 1, wherein the nanoparticles consist of a noble metal.

11. The signal transmitter as claimed in claim 1, wherein the nanoparticles are produced by, in particular laser ablation and/or abrasion.

12. The signal transmitter as claimed in claim 1, wherein the size and/or the size distribution and/or the shape of the nanoparticles are/is established in a self-assembled fashion, by use of repelling van der Waals forces.

13. The signal transmitter as claimed in claim 1, wherein the marking means (21, 24, 26) has a reflection maximum in the infrared spectrum.

14. A system for highlighting and recognizing objects in road traffic, comprising at least one signal transmitter and at least one signal detection module, wherein the at least one signal transmitter reflects impinging electromagnetic radiation in at least one predeterminable wavelength band, and wherein the at least one signal detection module detects an electromagnetic radiation reflected by the at least one signal transmitter by means of at least one infrared-sensitive detection element, wherein the at least one signal transmitter is a signal transmitter as claimed in claim 1.

15. The system as claimed in claim 14, wherein the signal detection module irradiates the at least one signal transmitter by at least one radiation element with electromagnetic radiation in a predeterminable wavelength band.

16. The system as claimed in claim 14, wherein the at least one radiation element is an LED.

17. The system as claimed in claim 16, wherein the LED, is an infrared LED, and is energized in a pulsed fashion.

18. The system as claimed in claim 17, wherein the at least one infrared-sensitive detection element and the LED infrared LED are operated in a synchronously pulsed fashion.

19. The system as claimed in claim 14, wherein the at least one detection element is a photodiode and/or a camera and/or a laser scanner.

20. The system as claimed in claim 16, wherein the signal detection module comprises two mutually independent detection elements and a separating screen, wherein active detection regions of the detection elements are oriented in different directions on a horizontal plane, and wherein the detection regions are determined by an arrangement of the separating screen.

21. The system as claimed in claim 19, wherein the at least one photodiode and/or the at least one camera and/or the at least one laser scanner are shielded against impinging electromagnetic radiation in a visible spectral range by means of a daylight barrier filter.

22. The system as claimed in claim 14, wherein the signal detection module, by use of wavelength-selective filters and/or different wavelength-dependent sensitivities of different detection elements, is capable of reading out a coded information item contained in a reflected wavelength of the signal transmitter.

23. The system as claimed in claim 19, wherein the at least one camera and/or the at least one laser scanner, in a resolution-governed manner, is capable of reading out coded information items kept in an at least one-dimensional barcode and/or in a two-dimensional symbol of the signal transmitter.

24. The system as claimed in claim 14, wherein a radiation power of the at least one radiation element and a reflectivity of the at least one signal transmitter and a sensitivity of the at least one detection element limit a recognition range of the system to 15 m.

25. The system as claimed in claim 14, wherein the signal detection module is affiliated with a driver assistance system of a motor vehicle and is capable of initiating an autonomous braking intervention and/or an autonomous steering intervention and/or a warning of a driver by means of optical and/or acoustic and/or haptic warning means.

26. The system as claimed in claim 14, wherein a housing of the detection module can be arranged on an inner side of a vehicle windshield by means of its wedge-shaped basic form.

27. A method for highlighting and recognizing objects in road traffic, in which an object is highlighted by at least one signal transmitter, wherein the at least one signal transmitter reflects impinging electromagnetic radiation in at least one predeterminable wavelength band, and wherein an electromagnetic radiation reflected by the at least one signal transmitter is detected by at least one signal detection module, wherein the at least one signal transmitter is a signal transmitter comprising a marking means and a carrier material, wherein the marking means is arranged on the carrier material in a manner covering at least one surface side of the carrier material and or is admixed with a substance of the carrier material (22, 24, 26), and wherein the signal transmitter reflects impinging electromagnetic radiation in at least one predeterminable wavelength band by the marking means, wherein a spectral width and a spectral position of the at least one predeterminable wavelength band are influenced by a size and/or a size distribution and/or a shape of nanoparticles contained in the marking means and/or are influenced by a surface nanostructuring of the marking means, and wherein the spectral position of the at least one predeterminable wavelength band lies in an infrared spectral range.

28. The method as claimed in claim 27, wherein the signal transmitter keeps at least one coded information item in machine-readable form, wherein the coded information item is contained in an at least one-dimensional barcode and/or a wavelength and/or at least one two-dimensional symbol, wherein the at least one signal detection module comprises a camera and/or a laser scanner which read(s) out the at least one information item, wherein the object is a traffic information provider, and wherein the traffic information provider is in particular a road sign and/or a roadway marking and/or a kilometer post and/or a traffic light and/or a lamp post and/or a reflector post and/or a traffic cone.

29. The method as claimed in claim 27, wherein the at least one information item read out is output optically and/or acoustically to a driver of a motor vehicle in a form comprehensible to said driver.

30. The method as claimed in claim 27, wherein the signal transmitter is applied to a road surface by a motor vehicle.

31. The use of the system as claimed in claim 14 in a driver assistance system of a motor vehicle.

32. The use of the signal transmitter as claimed in claim 1 for keeping a multiplicity of information items in machine-readable form in a road sign.

33. The signal transmitter as claimed in claim 1, wherein the spraying device is a spray can.

34. The signal transmitter as claimed in claim 1, wherein the noble metal comprises gold and/or an alkali metal.

35. The signal transmitter as claimed in claim 1, wherein the marking means has a reflection maximum in the near infrared spectrum of 700 nm to 1000 nm.
